(19) United States
(12) Patent Application Publication
(10) Pub. No.: US 2022/0250013 A1
(43) Pub. Date: Aug. 11, 2022

(54) Containment System for Mixing Dry Powders with Solvents During Drug Production or Processing

(71) Applicant: Merck Sharp & Dohme Corp., Rahway, NJ (US)

(72) Inventors: John H. Roosa, Hillsborough, NJ (US); Alan S. D'Alessandro, Forked River, NJ (US); Robert O'Connor, Aberdeen, NJ (US); Luke Schenck, Yardley, PA (US); Timothy Stanoch, Lansdale, PA (US)

(73) Assignee: Merck Sharp & Dohme Corp., Rahway, NJ (US)

(21) Appl. No.: 17/618,641

(22) PCT Filed: Jun. 15, 2020
(86) PCT No.: PCT/US2020/037734

§ 371 Date: Dec. 13, 2021

Related U.S. Application Data
(60) Provisional application No. 62/863,443, filed on Jun. 19, 2019.

(51) Int. Cl. B01F 21/10; B01F 35/71; B01F 35/75

(52) U.S. Cl. CPC B01F 21/10; B01F 2101/22; B01F 35/7547; B01F 35/71805

(57) ABSTRACT

A solids charging containment apparatus and method for mixing a solvent with a dry powder, comprising a dual compartment isolator for safely removing the dry powder from a dry powder container, a mixing vessel, and a negative cascading pressure controller. The dual compartment isolator comprises a staging compartment, a charging compartment and a raw material entry port, which is connected to the staging compartment and configured to isolate the dry powder container from the surrounding atmosphere. The mixing vessel includes a mixing chamber and a solids charging port fluidly connecting the mixing chamber to a containment valve in the charging compartment of the dual compartment isolator. The negative cascading pressure controller generates negative pressure in both the staging compartment and the charging compartment. The containment apparatus and method may be used to produce a slurry or solution mixture of solvent and dry powder during drug processing.

### FIELD OF THE INVENTION

The present invention relates to systems, methods and apparatus for processing a drug substance or product in a contained environment.

### BACKGROUND OF THE INVENTION

Pharmaceutical production has advanced considerably over the last two decades, and very potent ingredients, products and substances play an increasingly central role in the fight against many diseases, such as cancer. During production and processing of such potent pharmaceutical ingredients, products and substances, it is often necessary and/or more efficient for human operators to use their hands (or hand-operated tools and instruments) to handle containers of potent pharmaceutical ingredients, products and substances. In such situations, it is imperative that none of the potent pharmaceutical ingredients, products and substances is contaminated by the surrounding atmosphere, that none of the potent pharmaceutical ingredients, products or substances is released into the surrounding environment, and none of the potent pharmaceutical ingredients, products and substances come into direct physical contact with humans. Pharmaceutical products and ingredients are sometimes micronized. In these situations, inhalation of dust by humans is the primary concern. But liquid pharmaceutical products and ingredients, and liquid drug by-products, can also pose very serious danger to operators and the environment. Accordingly, during the entire process of manufacturing a pharmaceutical product, from synthesis of the pharmaceutically active ingredient to distribution of the finished medicinal product, human operators who handle the pharmaceuticals must be protected from direct contact with the pharmaceutical products and ingredients, and the pharmaceutical products and ingredients must be protected from contamination by the surrounding environment or by human contact.

Many pharmaceutical products, ingredients and substances are produced and/or processed inside “cleanrooms.” A cleanroom (or “clean room”) is a laboratory facility ordinarily utilized as a part of specialized industrial production or scientific research, including the manufacture of pharmaceutical products. Cleanrooms are designed to maintain extremely low levels of particulates, such as dust, airborne organisms, or vaporized particles. Cleanrooms typically have a cleanliness level quantified by the number of particles per cubic meter at a predetermined molecule measure. The ambient outdoor air in a typical urban area contains 35 million particles for each cubic meter, with each particle having a size range of at least 0.5 μm. This cleanliness level is equivalent to an ISO 9 cleanroom. By comparison, an ISO 1 cleanroom permits no particles in that size range and just 12 particles for each cubic meter, each particle having a size range of no more than 0.3 μm. The air entering a cleanroom from outside is typically filtered to exclude dust, and the air inside is constantly recirculated through high-efficiency particulate air (HEPA) filters and/or ultra-low particulate air (ULPA) filters to remove internally generated contaminants. Staff people must enter and leave through airlocks (sometimes including an air shower stage), and wear protective clothing such as hoods, face masks, gloves, boots, and coveralls. Equipment inside the cleanroom is designed to generate minimal air contamination. Only special mops and buckets are used. Cleanroom furniture is also designed to produce a minimum of particles and must be easy to clean and decontaminate.

In some situations, it is necessary or desirable to produce or process pharmaceuticals (drug substances and drug products) in a space that is classified as a “Grade C” space. A Grade C space is a space that meets the International Standards Organization (ISO) Cleanroom classification of ISO 8 when the space is “operational” (i.e., when the space is in use), and meets the cleanroom classification of ISO 7 when the space is at rest (i.e., when the space is not in use). Thus, when operational, a Grade C space is a space that has a maximum concentration of 3,520,000 particles per cubic meter for particles 0.5 microns, a maximum concentration of 832,200 particles per cubic meter for particles 1 micron, and a maximum concentration of 29,300 particles per cubic meter for particles 5 microns (consistent with ISO 8). When at rest, a Grade C space has a maximum concentration of 352,000 particles per cubic meter for particles 0.5 microns, a maximum concentration of 83,200 particles per cubic meter for particles 1 micron, and a maximum concentration of 2,930 particles per cubic meter for particles 5 microns (consistent with ISO 7). With all of these requirements, traditional Grade C-classified cleanrooms are extremely expensive (typically costing millions of dollars to build, maintain and operate), and occupy an enormous amount of space.

Therefore, there is considerable need in the pharmaceutical industry, for a containment system for processing and manufacturing drugs, and for handling drug by-products, that occupies a smaller “footprint” in a drug processing or manufacturing facility, and that requires much less money and time than conventional cleanrooms to build, maintain and use. Critically, such a containment system must permit potent drugs, drug ingredients and drug by-products to be handled in a manner that is just as safe as, and preferably even safer than, conventional containment systems, such as cleanrooms, in its capacity for providing triple protection, namely (1) preventing contamination of the drug products, (2) preventing contamination of the surrounding atmosphere, and (3) preventing the drug products, ingredients and by-products from coming into direct contact with human operators during production and processing.

### SUMMARY OF THE INVENTION

Embodiments of the present invention provide a solids charging containment apparatus, system and method that uses significantly less space, and requires considerably less time and money to build, use and maintain, while also providing and supporting improved triple protection for the product, for the surrounding environment and for human operators. Embodiments of the present invention may be beneficially used, for example, in the production of slurries or solutions from dry powder compositions of raw materials, such as active pharmaceutical ingredients (APIs) and drug products, while providing such triple protection. In some embodiments, the invention can provide a smaller, portable and much less expensive Grade C-classified space for production and processing of pharmaceuticals (such as drug substances and drug products), thereby avoiding the time, expense and effort required for building, maintaining and operating a conventional Grade C-classified space.

In general, containment systems of the present invention include a dual compartment flexible isolator, with cascading differential pressure between the dual compartments. The dual compartments are sometimes referred to herein as first and second compartments. A negative pressure cascade is maintained within the system to ensure that raw material does not escape into to the surrounding environment. Negative pressure is also used to prevent cross-contamination between the two compartments. Differential negative pressure is assured by providing a negative pressure controller, which substantially reduces or eliminates the chances of (1) airborne particles in the first compartment passing out of the first compartment and into the surrounding environment, and (2) airborne particles in the second compartment passing out of the second compartment and into the first compartment.

In one aspect, embodiments of the present invention provide a containment system for mixing a solvent with a dry powder without exposing the dry powder to a surrounding atmosphere. The dry powder is supplied to the system in a dry powder container having a sealed connection. The containment system comprises (a) a dual compartment isolator for safely removing the dry powder from the dry powder container, and (b) a mixing vessel. The dual compartment isolator includes a staging compartment, a charging compartment, a raw material entry port connected to the staging compartment, the raw material entry port being configured to isolate the dry powder container from the surrounding atmosphere while transferring the dry powder container into the staging compartment. A partition separates the staging compartment from the charging compartment. A resealable opening in the partition allows the dry powder container to be transferred out of the staging compartment and into the charging compartment without exposing the dry powder to the surrounding atmosphere.

A containment valve, located inside the charging compartment, has a fitting suitably configured to mate with the sealed connection on the dry powder container. The negative cascading pressure controller generates negative pressure in both the staging compartment and the charging compartment. The containment valve allows a human operator to couple the dry powder container to the mixing vessel. The body of the containment valve also may have a shield around its body to provide additional protection against any particles escaping from the containment valve itself, the connection to the mixing vessel and/or the dry powder container. The containment valve provides an airtight conduit to convey the dry powder from the dry powder container to the mixing vessel. The containment valve may comprise a butterfly valve or a dry-lock valve.

The mixing vessel, which may be, but need not be, made of glass, steel, a polymer, or a borosilicate, for example, includes a mixing chamber, a solids charging port fluidly connecting the mixing chamber to the containment valve in the charging compartment of the dual compartment isolator. The solids charging port permits the dry powder to pass out of the containment valve and into the mixing chamber without exposing the dry powder to the surrounding atmosphere. The mixing vessel typically includes a solvent inlet for admitting a solvent into the mixing chamber, and in some embodiments, but not necessarily in all embodiments, the mixing vessel includes an agitator for mixing the solvent and the dry powder together in the mixing chamber. The system may be used to produce a mixture of solvent and dry powder in the mixing chamber, the mixture comprising, for example, a slurry or a solution. The mixing vessel may also include an outlet valve for discharging the solvent and dry powder mixture (such as a slurry or solution) from the mixing chamber. In some embodiments of the invention, the containment system further comprises a discharge device for facilitating the discharge of the mixture from the mixing chamber via the outlet valve. The discharge device may comprise, for example, a pump, a positive pressure source, or a negative pressure source, such as a vacuum.

In additional embodiments of the present invention, the negative cascading pressure controller is configured to fill the interior of the staging compartment and/or the interior of the charging compartment with an inert gas, such as, for example, nitrogen or argon. The negative cascading pressure controller typically provides a negative pressure differential between the outside of the dual compartment isolator and the staging compartment of about 0.01 to about 0.5 inches of water (negative pressure referenced from the outside of the dual compartment isolator), and a second negative pressure differential between the staging compartment and the charging compartment of about 0.010 to about 0.500 inches of water (negative pressure referenced from the inside of the staging compartment of the dual compartment isolator). The typical operating range for negative pressure inside the staging compartment (as compared to the outside of the isolator) is preferably between about 0.005 and 0.125 inches of water, more preferably between about 0.010 and 0.100 inches of water, and most preferably between about 0.015 and 0.075 inches of water. The typical operating range for negative pressure inside the charging compartment (as compared to the inside of the staging compartment) is preferably between about 0.010 and 0.125 inches of water, more preferably between about 0.015 and 0.100 inches of water, and most preferably between about 0.020 and 0.075 inches of water.

Negative pressure may be generated and maintained by a ventilation system that constantly removes a larger amount of gas from each chamber of the isolator than the amount of gas that is allowed to enter into each chamber of the isolator. Both the inlet gas and the exhaust stream to the ventilator may be properly filtered (with HEPA filters or cartridges, for example). The differential pressure (AP) between the external environment and the working volume inside the isolator helps to prevent dry powder particles from escaping into the external environment via leaks in the physical barriers of the dual chamber flexible isolator. In fact, any possible leak through a crevice will be into the isolator, which prevents the spread of dry powder particles. The negative pressure inside the dual compartment isolator also serves to help keep dry powder inside the isolator if a door or port of the isolator is opened accidentally, or if a glove is accidentally torn or ruptured. In some embodiments, the flexible isolator may include a ventilation system that can be activated to replace most or all of the oxygen (O) inside the isolator with an inert gas, such as Nitrogen (N²) or argon (Ar), so that any degradation of drug substance or drug product is minimized, and it is safer to use the isolator for handling or processing potentially flammable or explosive materials.

In another implementation of the present invention, also comprising a dual compartment isolator, a negative cascading pressure controller and a mixing vessel, the dual compartment isolator comprises a top portion and a bottom portion, the top and the bottom portions being linked together by one or more side walls to form an interior portion having an internal wall that separates the interior portion into a first compartment and a second compartment. One or more sleeves terminating in gloves formed in one or more of the side walls extend into one or both compartments of the interior portion of the isolator. The one or more sleeves and gloves are constructed to receive and protect a human operator's hands, wrists and arms while the human operator handles dry powder containers inside the isolator.

A first sealable opening formed in one of the side walls of the first compartment permits the sealed dry powder container to be transferred from outside of the isolator to the inside of the first compartment. Typically, the dry powder container is cleaned, sanitized and/or disinfected inside the first compartment to remove most or all of any dry powder particles or other undesirable dust particles or liquids from the exterior surfaces of the sealed dry powder container. A second sealable opening formed in the internal wall between the first compartment and the second compartment permits the sealed dry powder container to be transferred from the first compartment and into the second compartment without exposing the dry powder container to the surrounding atmosphere.

A containment valve, located inside the second compartment, has a fitting suitably configured to mate with the sealed connection on the dry powder container. The negative cascading pressure controller is operable to generate sufficient negative pressure within the first compartment and the second compartment to (1) prevent airborne particles in the first compartment from passing out of the first compartment and into the surrounding environment through the first sealable opening in the first compartment, and (2) prevent airborne particles in the second compartment from passing out of the second compartment and into the first compartment through the second sealable opening formed in the internal wall between the first compartment and the second compartment.

The mixing vessel includes a mixing chamber and a solids charging port fluidly connecting the mixing chamber to the containment valve in the first compartment of the dual compartment isolator. The connection of the dry powder container to the containment valve, and the connection of the containment valve to the solids charging port on the mixing vessel allows the dry powder to pass out of the dry powder container through the containment valve and into the mixing chamber without exposing the dry powder to the surrounding atmosphere. A solvent inlet on the mixing vessel is used to admit a solvent into the mixing chamber, where it will be mixed with the dry powder, preferably by activation of an agitator disposed within the mixing chamber. Mixing the solvent with the dry powder with the agitator inside the mixing vessel produces a solvent and dry powder mixture, such as a slurry or solution. An outlet valve in the mixing vessel enables discharging the solvent and dry powder mixture from the mixing chamber.

In some embodiments of the present invention, the dual compartment flexible isolator comprises four side walls arranged to define an interior portion that is substantially rectangular (i.e., forming an interior portion that is shaped like a “box” or “cube”). In other embodiments, the dual compartment flexible isolator may comprise circular or oval-shaped top and bottom portions and a single cylindrically-shaped side wall that is sealingly connected to the circular or oval-shaped top and bottom portions so that the top portion, bottom portion and single sidewall together define an interior portion that is substantially cylindrical in shape. In still other embodiments, the top portion, bottom portion and side walls may also be arranged and connected to define an interior portion that is substantially in the shape of a triangular solid or pyramid. Regardless of shape of the interior portion of the dual compartment flexible isolator, it will be understood by those skilled in the art that the first and second compartments may be located next to each other (i.e., in a horizontal or “side-by-side” configuration), or rotated so that one of the compartments is located above or below the other compartment (i.e., in a vertical configuration), without departing from the scope of the claimed invention. The side walls of the dual compartment flexible isolator may be formed from any suitably flexible material, such as, for example, polyvinylchloride, polyethylene, polypropylene (PP), or polystyrene. Some embodiments of the present invention may include one or more glove and sleeve combinations formed in the side walls of both of the compartments of the dual compartment flexible isolator to protect the operators' hands, wrists and arms from direct contact with the dry powder, the slurry or the solution, or drug by-products. In some embodiments of the present invention, the first sealable opening and/or the second sealable opening comprises a zip-lock seal, or a clamp, or a crimped seal, or a twist-seal, although other types of seals may be used without departing from the scope of the claimed invention.

In some embodiments of the present invention, the containment system further comprises yet another port for connecting the flexible isolator to another system, process or device. The additional port may, for example, be selectively connected to (i) a vacuum source, and (ii) a source of inert gas, so that the air inside the enclosure may be replaced by the inert gas.

In various embodiments of the invention, the containment system further comprises a solvent tank that is fluidly connected to the mixing vessel via the solvent inlet.

In additional embodiments of the invention, the containment system further comprises a second solvent inlet on the mixing vessel, configured to admit a second solvent into the mixing chamber. In some embodiments of the invention, the second solvent inlet may be used to admit into the mixing vessel an anti-solvent. In such embodiments of the present invention, the containment system further comprises an anti-solvent tank for providing anti-solvent to the mixture produced in the mixing chamber.

In another implementation, an embodiment of the present invention provides a dual compartment flexible isolator comprising (i) a top portion and a bottom portion, (ii) at least one glove, (iii) a first sealable opening, (iv) a second sealable opening, (v) a containment valve, and (vi) a negative cascading pressure controller. The top portion and the bottom portion are linked together by one or more side walls, forming an interior portion comprising an internal wall that is sealingly connected to the one or more side walls and that separates the interior portion into a first compartment and a second compartment. The at least one glove is formed in at least one of the side walls and configured to be extendible into the interior of the flexible isolator. The first sealable opening is formed in one of the side walls and thereby permits a dry powder material container to be placed inside the first compartment. The second sealable opening is formed in the internal wall and permits the dry powder container to be moved from the first compartment into the second compartment without exposing the dry powder to the surrounding atmosphere. The containment valve, located inside the second compartment, has a fitting suitably configured to mate with the sealed connection on the dry powder container. The negative cascading pressure controller generates negative pressure within the first compartment and the second compartment to substantially reduce or eliminate the chances of airborne particles passing out of the second compartment and into the first compartment, or passing out of the first compartment and into the surrounding environment.

In addition, or as an alternative to gloves, embodiments of the present invention may be equipped with other devices that allow operators to manipulate items within the isolation space (i.e., the isolation compartments). Such devices include, but are not limited to, extended sleeves and robotic arms. The isolator may also have from one or more inlet and outlet ports that allow access to the isolation space through side walls to facilitate admitting or removing various products, substances and materials, such as pressurized gas, running water, electrical power, and the like.

The flexible isolator may further include one or more probes and/or sensors, without any limitation to particular types of probes or sensors. The sensors may include, for instance, temperature, pressure, p(O2), or p(N2) sensors, or alarm devices. The sensors or probes may be connected to or controlled by a computer system. Information collected by the sensors and/or probes may be transmitted to and/or saved on the computer system. Continuously monitoring the pressure inside the isolator with a pressure sensor is one approach that may be used to determine whether any holes or leaks have formed in the isolator.

In still another aspect, the present invention provides a containment system for mixing a solvent with a dry powder without exposing the dry powder to surrounding atmosphere, wherein the containment system comprises: a) a primary containment subsystem comprising a split butterfly valve SBV with a fitting configured to accept a sealed connection on a dry powder container, and a connection to solids charging port of a mixing vessel; and b) a secondary containment subsystem comprising the mixing vessel, a dual compartment flexible isolator, and a negative cascading pressure controller. In some embodiments, the containment system of the invention further comprises a tertiary containment subsystem comprising a negatively-pressurized room, or a down-flow booth, or a gas exhaust, or a solvent exhaust, or protective flooring, or a single-use protective curtain, or a combination of one or more thereof.

In some embodiments of the present invention, the dual compartment flexible isolator comprises a staging compartment, a charging compartment, a raw material entry port, connected to the staging compartment, the raw material entry port being configured to isolate the dry powder container from the surrounding atmosphere while transferring the dry powder container into the staging compartment, a partition separating the staging compartment from the charging compartment, and a resealable opening in the partition that permits the dry powder container to be transferred out of the staging compartment and into the charging compartment without exposing the dry powder to the surrounding atmosphere.

In still another aspect, the present invention provides a method of producing a slurry or solution from a dry powder and a solvent. The method includes the steps of:
(a) providing a dual compartment isolator, the dual compartment isolator comprising a staging compartment, a raw material entry port connected to the staging compartment, a charging compartment, a containment valve located in the charging compartment, and a partition between the staging compartment and the charging compartment,
(b) connecting a negative cascading pressure controller to the dual compartment isolator;
(c) providing a mixing vessel comprising a solvent inlet, a mixing chamber and a solids charging port fluidly connected to the mixing chamber;
(d) receiving a dry powder container containing the dry powder, the dry powder container having a sealed connection;
(e) activating the negative cascading pressure controller to produce negative pressure in both the staging compartment and the charging compartment of the dual compartment isolator;
(f) admitting the dry powder container into the staging compartment via the raw material entry port;
(g) transferring the dry powder container from the staging compartment to the charging compartment by passing the dry powder container through a resealable opening in the partition;
(h) closing the resealable opening in the partition;
(i) connecting the sealed connection on the dry powder container to a fitting on one end of the containment valve in the charging compartment of the dual compartment isolator;
(j) connecting the solids charging port on the mixing vessel to an opposite end of the containment valve;
(k) opening the sealed connection on the dry powder container, the fitting on the containment valve and the solids charging port on the mixing vessel so that the dry powder will pass out of the dry powder container in the charging compartment of the dual compartment isolator, through the sealed connection, the fitting and the solids charging port, and into the mixing chamber of the mixing vessel;
(l) introducing the solvent into the mixing chamber of the mixing vessel via the solvent inlet; and
(m) agitating the dry powder and the solvent in the mixing chamber to produce the slurry or solution.

In some embodiments of the present invention, the method further comprises adding anti-solvent to the composition formed in the mixing chamber of the mixing vessel to form a slurry. In other embodiments of the invention, the solvent that is introduced into the mixing chamber dissolves the dry powder to produce the solution.

In additional embodiments of the present invention, the mixing vessel further comprises a second solvent inlet and the method further comprises (i) introducing an anti-solvent into the mixing chamber of the mixing vessel via the second solvent inlet; and (ii) agitating the dry powder and the anti-solvent in the mixing chamber to produce the slurry.

In still other embodiments of the present invention, the method further comprises performing a staging procedure while the dry powder container is inside the staging compartment, wherein the staging procedure comprises cleaning the dry powder container. The dry powder container may be cleaned by with appropriate solutions such as water or alcohol. Suitable alcohols include, but not limited to, isopropanol or methanol.

In additional embodiments of the present invention, the method further comprises attaching a transfer device to the mixing vessel and activating the transfer device to facilitate discharging the slurry or solution out of the mixing vessel. The transfer device may comprise a pump, a positive pressure source, or a negative pressure source, such as a vacuum or suction device.

### BRIEF DESCRIPTION OF THE DRAWINGS

FIG. 1 is a block diagram of an exemplary containment system of the present invention;

FIG. 2 is a perspective view of an exemplary containment system of the present invention;

FIGS. 3A and 3B show additional perspective views of the exemplary containment system of the present invention;

FIGS. 4A and 4B together show a flow diagram illustrating the process of operation of a containment system in accordance with the present invention;

FIG. 5 is perspective view of an embodiment of a raw material entry port of an exemplary dual compartment flexible isolator of an embodiment of containment system of the present invention;

FIG. 6 is a perspective view of an operator sleeve of an exemplary dual compartment flexible isolator of a containment system of the present invention;

FIG. 7 is a perspective view of an embodiment of a solids charging port associated with a containment system in accordance with the present invention;

FIG. 8 is a perspective view of an exemplary containment valve used in an embodiment of a containment system of the present invention;

FIG. 9 shows an example of a dry powder container that may be used with embodiments of the present invention to supply the dry powder.

FIG. 10 is a perspective view of a mixing vessel attached to an exemplary dual compartment isolator in accordance with an exemplary embodiment of a containment system the present invention;

FIG. 11A shows an exemplary optional wet milling apparatus that may be used with embodiments of the present invention to reduce the particles in the mixture, solution or slurry created in the containment system to a uniform particle size, resulting in faster drying times and higher quality dry powders. FIG. 11B is a perspective view of an exemplary wet mill that may be used in certain embodiments of a containment system configured to operate in accordance with an embodiment of the present invention.

FIG. 12 is a perspective view of an anti-solvent vessel associated with an exemplary dual compartment isolator of the present invention;

FIG. 13 is a schematic perspective view illustrating an air pressure pump associated with an exemplary dual compartment flexible isolator in accordance with an embodiment of a containment system of the present invention;

FIG. 14 is a perspective view of solvent tanks used in accordance with various embodiments of the containment system of the present invention;

FIG. 15 is a perspective view of exemplary solvent supply lines used in accordance with various embodiments of the containment system of the present invention;

### DETAILED DESCRIPTION OF EXEMPLARY EMBODIMENTS

By way of overview, exemplary embodiments of the present invention provide a system, apparatus and method that permits good manufacturing practice (GMP) levels of containment of raw material, such as a pharmaceutical substance or product, while the raw material is mixed with a solvent to produce a slurry or solution. Advantageously, embodiments of the present invention are usable in small, compact spaces (relative to the space required for conventional clean rooms used in sterile pharmaceutical manufacturing), flexible, easy to use and readily disposable after use.

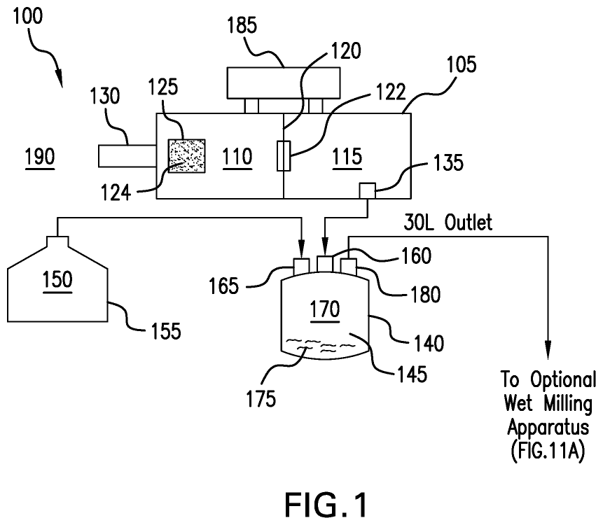

FIG. 1 shows an exemplary containment system 100 of the present invention. As shown in FIG. 1, the containment system 100 is configured to contain a dual compartment isolator 105 and a mixing vessel 140. The dual compartment isolator 105, which facilitates safe removal of a dry powder 124 from a dry powder container 125, has a staging compartment 110, a charging compartment 115, and a raw material entry port 130 connected to the staging compartment 110. The raw material entry port 130 is configured to isolate the dry powder container 125 from the surrounding atmosphere while transferring the dry powder container 125 into the staging compartment 110. A partition 120 separates the staging compartment 110 from the charging compartment 115. The partition 120 has a resealable opening 122 that permits the dry powder container 125 to be transferred out of the staging compartment 110 and into the charging compartment 115 without exposing the dry powder 124 to the surrounding atmosphere 190.

The containment system 100 also includes a containment valve 135, located inside the charging compartment 115. The containment valve 135 has a fitting (not shown in FIG. 1) that is configured to mate with a sealed connection on the dry powder container 125. The containment system 100 also includes a negative cascading pressure controller 185 for generating negative pressure in both the staging compartment 110 and the charging compartment 115.

The containment system 100 also includes a mixing vessel 140 for mixing the dry powder with a solvent 150 from a solvent vessel 155. The mixing vessel 140 includes a mixing chamber 145, a solids charging port 160 fluidly connecting the mixing chamber 145 to the containment valve 135 in the charging compartment 115 of the dual compartment isolator 105 to permit the dry powder 124 to pass out of the dry powder container 125 through the containment valve 135 and into the mixing chamber 145 without exposing the dry powder 124 to the surrounding atmosphere 190.

The mixing vessel 140 also includes a solvent inlet 165 for admitting the solvent 150 into the mixing chamber 145. Preferably, an agitator (not shown in FIG. 1), suspended inside the interior 170 of the mixing chamber 145 may be activated to mix the solvent 150 and the dry powder 124 together in the mixing chamber 145 to produce a solvent and dry powder mixture 175. The mixing vessel 140 also includes an outlet port 180 for discharging the solvent and dry powder mixture 175 from the mixing chamber 145. The solvent and dry powder mixture may comprise a slurry or a solution.

The lid of the mixing vessel 140 preferably has the following ports: a solvent inlet 165 comprising a dip tube, a nitrogen supply, a sample port via dip tube, an outlet dip tube, a butterfly valve for solids charging and a vent. Preferably, the sample port and associated dip tube is routed to the charging compartment 115 of the dual compartment isolator 105, and facilitates contained sampling in a Grade C environment. The butterfly valve may be any suitable size. But the valve is preferably from 2-6 inches in diameter.

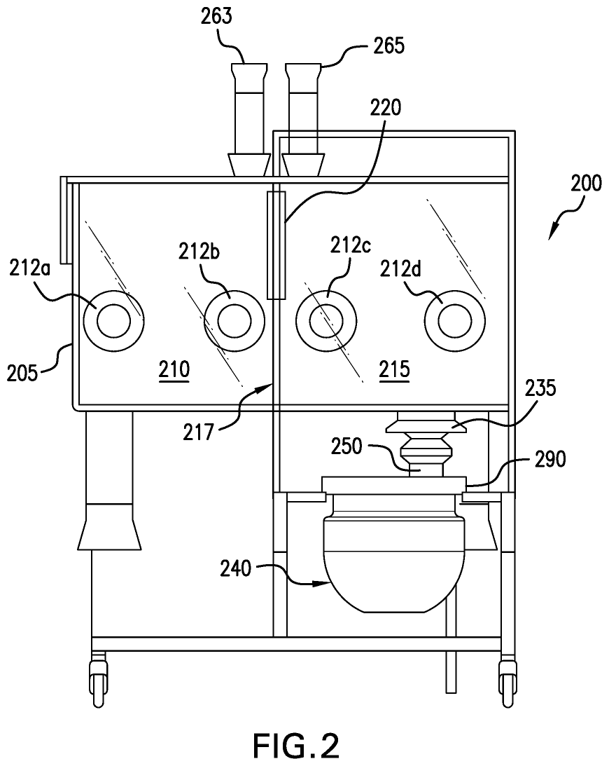

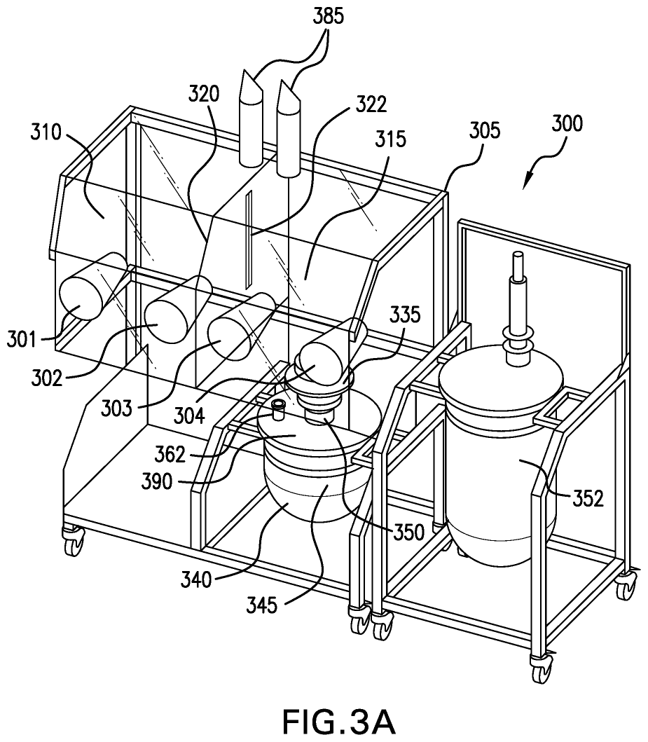

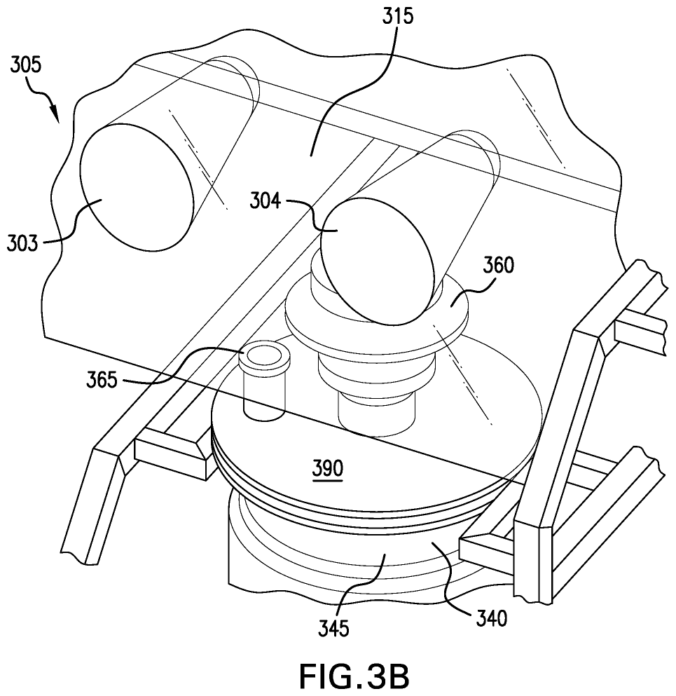

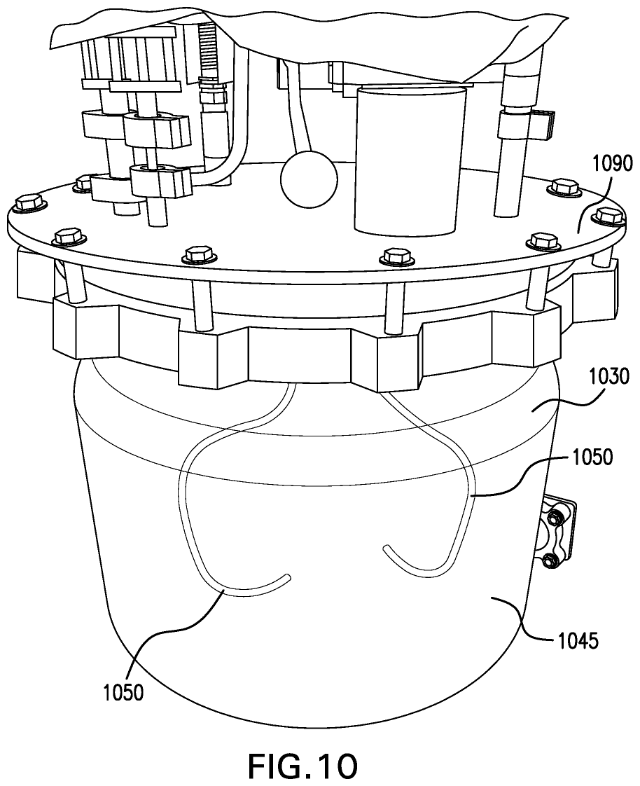

FIG. 2 shows a containment system 200 according to one embodiment of the present invention, comprising a dual compartment flexible isolator 205 that has a staging compartment 210, a charging compartment 215, a partition 217 with a resealable opening 220, and a 30 liter (30 L) mixing vessel 240 with a lid 290. In the exemplary embodiment shown in FIG. 2, the staging compartment 210 and the charging compartment 215 of the dual compartment flexible isolator 205 include four orifices 212a, 212b, 212c and 212d configured to connect four sleeve and glove combinations (not shown in FIG. 2) so that operators may insert their hands into the staging compartment 210 and the charging compartment 215 in order to manipulate the dry power container 125 while it is being cleaned and transferred from one compartment to the other. The 30 L mixing vessel 240 may be jacketed and equipped with an air powered overhead agitator (one example of an agitator is shown in FIG. 10 and designated with reference number 1050). A solids charging port 250 on the 30 L 240 vessel is connected to a containment valve 235 (e.g., a split butterfly valve) located in the charging compartment 215 of the dual compartment flexible isolator 205. FIGS. 3A and 3B show additional perspective views of an exemplary embodiment of a containment system configured in accordance with the present invention. FIG. 3A shows a containment system 300 that includes a dual compartment flexible isolator 305 comprising a staging compartment 310 and a charging compartment 315 separated by a partition 320 with a resealable opening 322. The containment system 300 also includes a 30 L mixing vessel 340 with a lid 390 and a mixing chamber 345. The mixing vessel 340 has a charging port 350, which is connected to a containment valve 335, which in turn is connected to the bottom of the charging compartment 315 of the dual compartment flexible isolator 305. As shown in FIG. 3A, the staging compartment 310 and charging compartment 315 may also include a plurality of sleeve and glove combinations 301, 302, 303 and 304. The containment system 300 may also include a solvent tank 352. Solvent stored inside the solvent tank 352 may be introduced into the mixing chamber 345 of the 30 L mixing vessel 340 by pumping or pulling the solvent through a suitable arrangement of ports and tubes (not shown in FIG. 3 for clarity) connecting the solvent tank 352 to the lid 390 of the 30 L mixing vessel 340. An outlet port 362 provides a means of extracting slurries or solutions from the mixing chamber 345 of the 30 L mixing vessel 340.

FIG. 3B is an perspective view of the charging compartment 315 of the dual compartment flexible isolator 305 of the containment system depicted in FIG. 3A, containing sleeve and glove combinations 303 and 304. For clarity in the drawings, the gloves are not shown. FIG. 3B also shows a portion of the mixing vessel 340, comprising the mixing chamber 345 and a lid 390 containing a solvent inlet port 365, outlet port 180 and solids charging port 360.

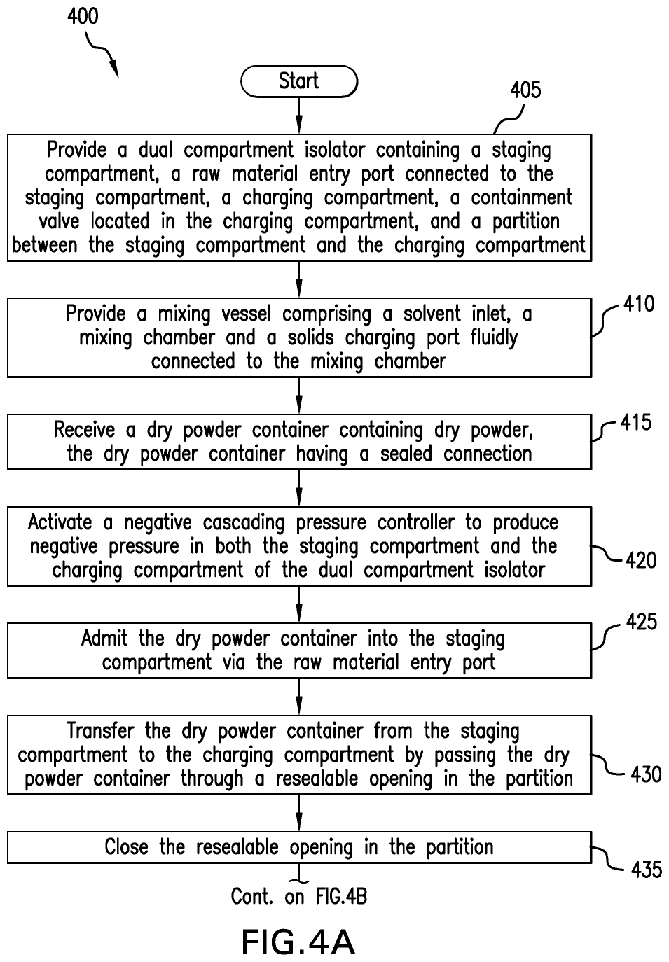

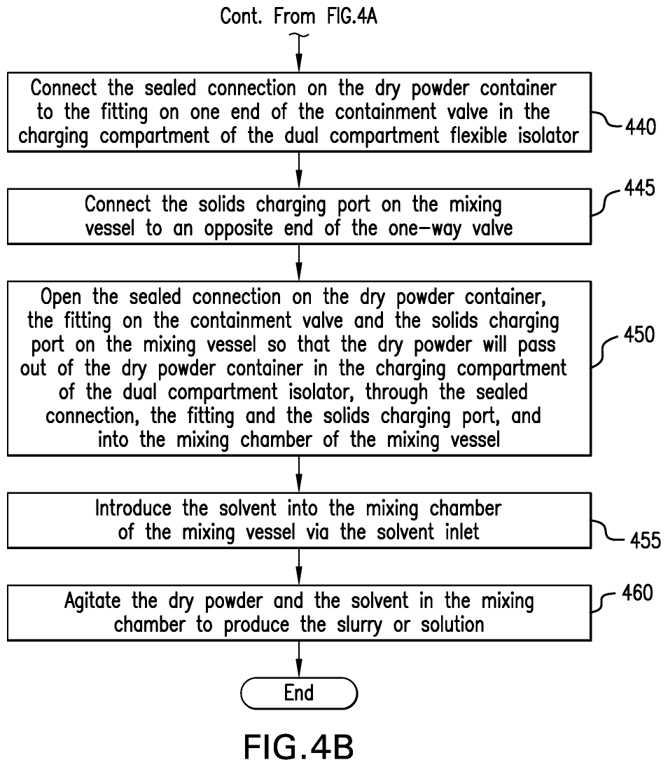

FIGS. 4A and 4B together show a flow diagram illustrating a method of producing a slurry or solution from a dry powder and a solvent in accordance with an embodiment of the present invention. As a first step 405, a dual compartment isolator 105 is provided. The dual compartment isolator 105 comprises a staging compartment 110, a raw material entry port 130 connected to the staging compartment 110, a charging compartment 115, a containment valve 135 located in the charging compartment 115, and a partition 120 between the staging compartment 110 and the charging compartment 115. Step 410 provides a mixing vessel 140 comprising a solvent inlet 165, a mixing chamber 145 and a solids charging port 160 fluidly connected to the mixing chamber 145.

At Step 415, a dry powder container 125 containing the dry powder 124 is received. The dry powder container has a sealed connection. Then, at Step 420, a negative cascading pressure controller 185 is activated to produce negative pressure in both the staging compartment 110 and the charging compartment 115 of the dual compartment isolator 105. At Step 425, the dry powder container is admitted to into the staging compartment via the raw material entry port 130. A user may pass raw material (for e.g., a drug substance or a drug product) and processing equipment of choice (for example funnels, scoops, etc.) into the staging compartment 110 through the raw material entry port 130. The raw material entry port 130 may be a poly sleeve. The raw material entry port 130 is then tied off, thereby providing a seal to the compartment from the outside environment.

Step 430 transfers the dry powder container 125 from the staging compartment 110 to the charging compartment 115 by passing the dry powder container 125 through a resealable opening in the partition 122. The resealable opening 122 in the partition 120 is then closed at step 435. At Step 440, the sealed connection on the dry powder container 125 is connected to a fitting on one end of the containment valve 135 in the charging compartment 115 of the dual compartment isolator 105. Then, at Step 445, the solids charging port 160 on the mixing vessel 140 is connected to an opposite end of the containment valve 135.

Step 450 includes opening a) the sealed connection on the dry powder container 125, b) the fitting on the containment valve 135 and the solids charging port 160 on the mixing vessel 140 so that the dry powder 124 will pass out of the dry powder container 125 in the charging compartment 115 of the dual compartment isolator 105, through the sealed connection, the fitting and the solids charging port 160, and into the mixing chamber 145 of the mixing vessel 140. The mixing vessel 140, for example a 30 L mixing vessel, may be jacketed and heated or cooled using, for example, an associated Huber unit to control the jacket temperature.

At Step 455, the solvent 150 is then introduced into the mixing chamber 145 of the mixing vessel 140, via the solvent inlet 165. Solvent 150 is charged from a nitrogen inerted vessel or tank 155, preferably made of stainless steel, through an in-line filter into the mixing vessel 140, for example, the 30 L vessel. Finally, at Step 460, the dry powder 124 and the solvent 150 are agitated in the mixing chamber 145 to produce the slurry or solution 175.

Optionally, the mixture of solvent and desired material is further processed by subjecting the mixture to wet milling to reduce drug particle size and improve drug solubility. Any type of milling and milling device that is suitable for producing nanoparticles may be employed in conjunction with the present invention. Exemplary types of milling operations may include, without limitation, wet milling, media milling, cryogenic milling and high-pressure homogenization.

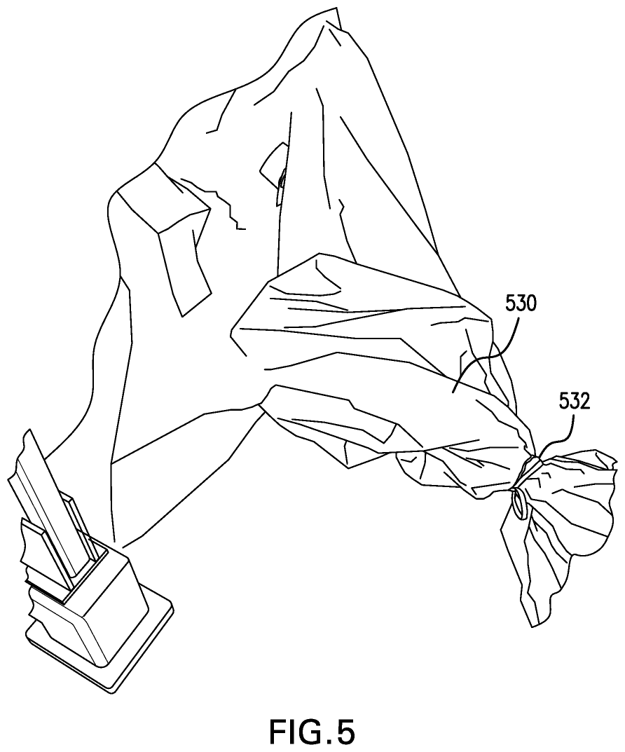

FIG. 5 depicts an exemplary raw material entry port 530 of a dual compartment isolator that is useful in the containment systems of the invention. As shown in FIG. 5, the raw material entry port 530 typically comprises a flexible, tubular-shaped plastic conduit, duct or sleeve, suitably large enough in diameter to permit the dry powder container 125 to be transferred from the outside environment and into the staging compartment of the containment system. Preferably, the open end of the raw material entry port 530 may be twisted closed and tied off with a suitable string, rope, strap, tie or crimp 532 after the dry powder container 125 is inside, so that little to no air or airborne particles can pass through the open end in either direction.

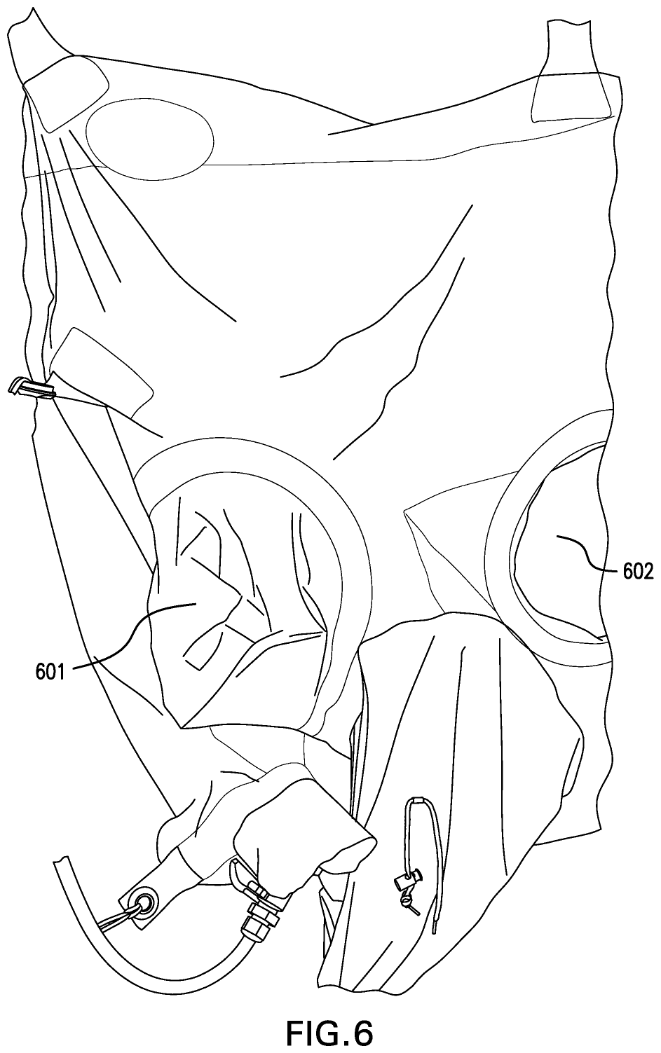

FIG. 6 shows operator sleeves 601 and 602 sealingly connected to a wall of a dual compartment isolator of a containment system of the present invention. The operator sleeves are used by the operator to manipulate material and items that are inside the staging and charging compartments of the dual compartment flexible isolators of the invention. The operator sleeves 601 and 602 also may be used as staging compartments for removing wastes and for introducing and removing cleaning supplies, and sanitizing agents. Sanitizing agents, such as vaporized hydrogen peroxide (VHP) may also be introduced into the dual compartment isolator via sanitary connection ports in one or both of the dual compartments.

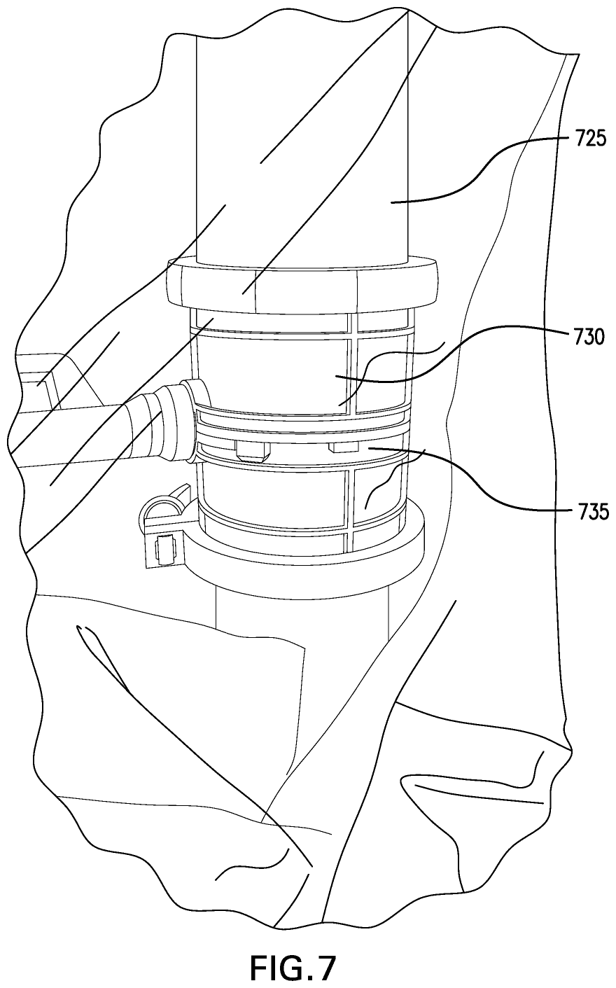

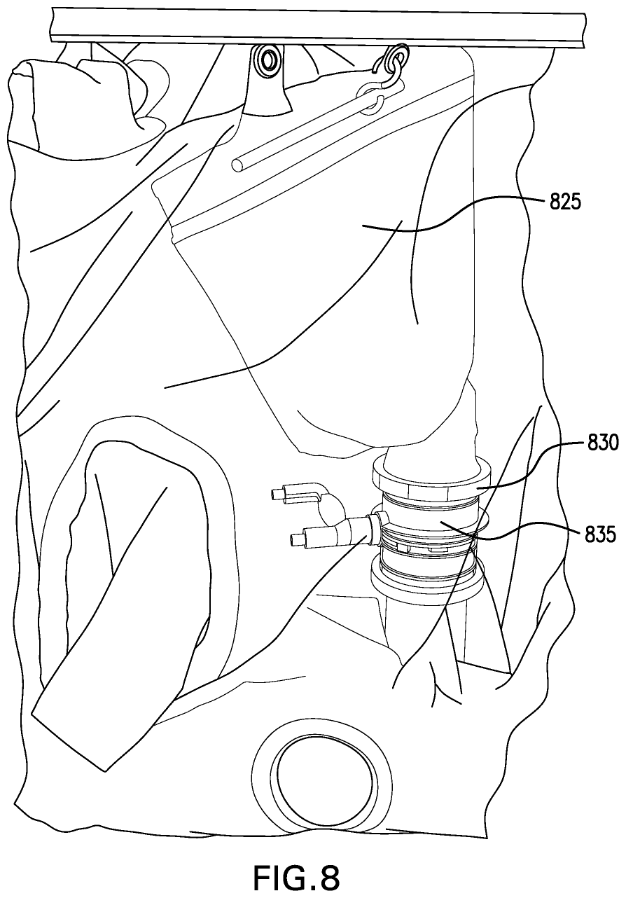

FIGS. 7 and 8 provide perspective views of an embodiment of a containment valve 735 and 835 respectively, associated with a containment system in accordance with the present invention. The containment valves 735 and 835 are split butterfly valves, which are connected, respectively, to the sealed connections 730 and 830 of dry powder containers 725 and 825. FIG. 8 also shows an embodiment of a dry powder container 825 with a sealed connection 830 mated to the split butterfly valve 835.

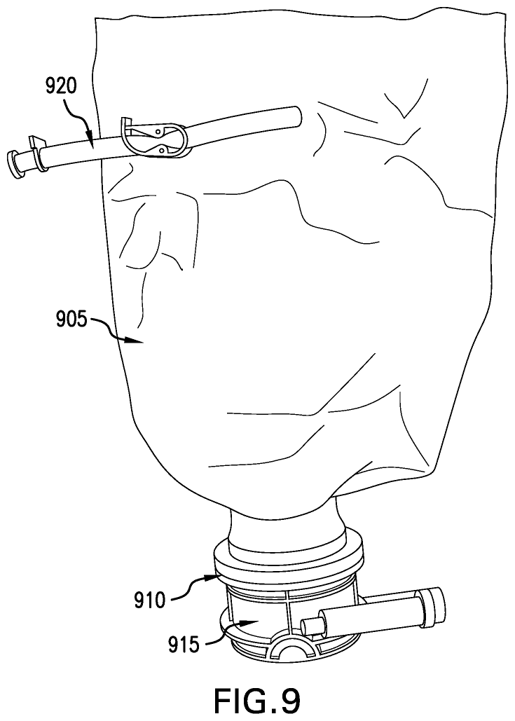

FIG. 9 shows an example of a dry powder container 905 having a sealed connection 910, wherein the sealed connection 910 comprises a clamp. As shown in FIG. 9, the sealed connection 910 is coupled to the top portion of a containment valve 915. In the example of the dry powder container 905 shown in FIG. 9, there is provided a flush port 920 attached to the dry powder container 905, which is configured to permit wetting of the dry powder inside the dry powder container 905.

FIG. 10 is a perspective view of a mixing vessel 1030, a mixing chamber 1045 and lid 1090 that may be used in accordance with an exemplary embodiment of a containment system of the present invention. The mixing vessel 1030 includes an agitator 1050 for mixing solvent, slurries and solutions in the mixing chamber 1045. The lid 1090, which is preferably substantially flat and constructed out of stainless steel, has multiple vessel ports therethrough to facilitate chemical synthesis. In alternative embodiments, the lid 1090 may be constructed out of glass and/or may have the shape of a dome.

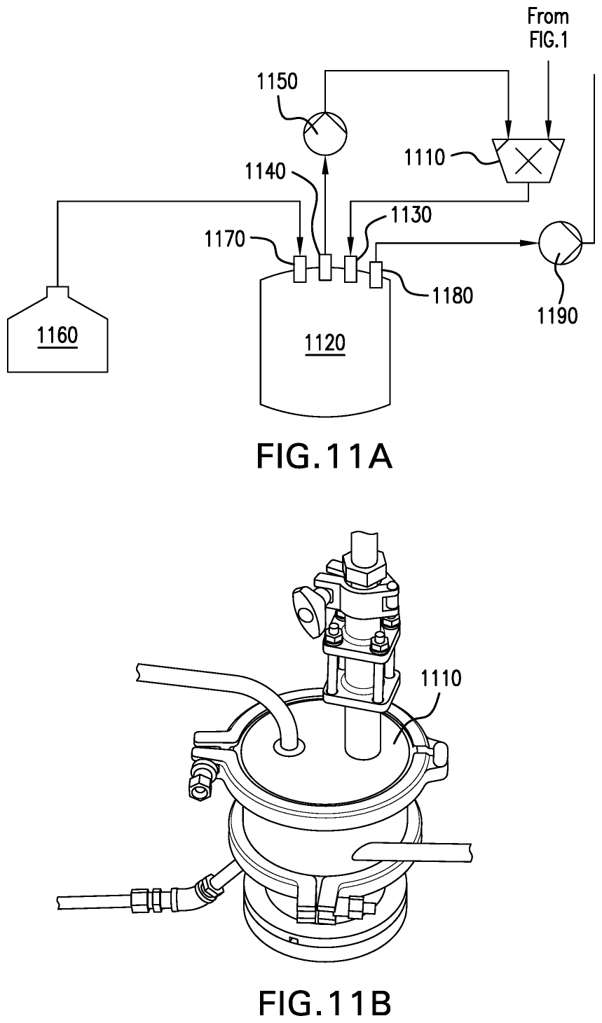

FIG. 11A shows an exemplary wet milling apparatus 1100 that could be used with various embodiments of the present invention to reduce the particles in the mixture, solution or slurry to a smaller particle size, resulting in faster drying times and higher quality dry powders. As shown in FIG. 11A, the milling apparatus 1100 includes a wet milling device 1110, which could be utilized for nanocrystalline precipitation, amorphous precipitation, or precipitation of micronized crystalline material in the 1-5 um range. The wet mill device 1110 includes an inlet port for admitting the mixture, slurry or solution from the mixing vessel 140 (of FIG. 1), and an outlet port for discharging the milled mixture, solution or slurry into a precipitation vessel 1120, which may be, for example, a 100 L vessel.

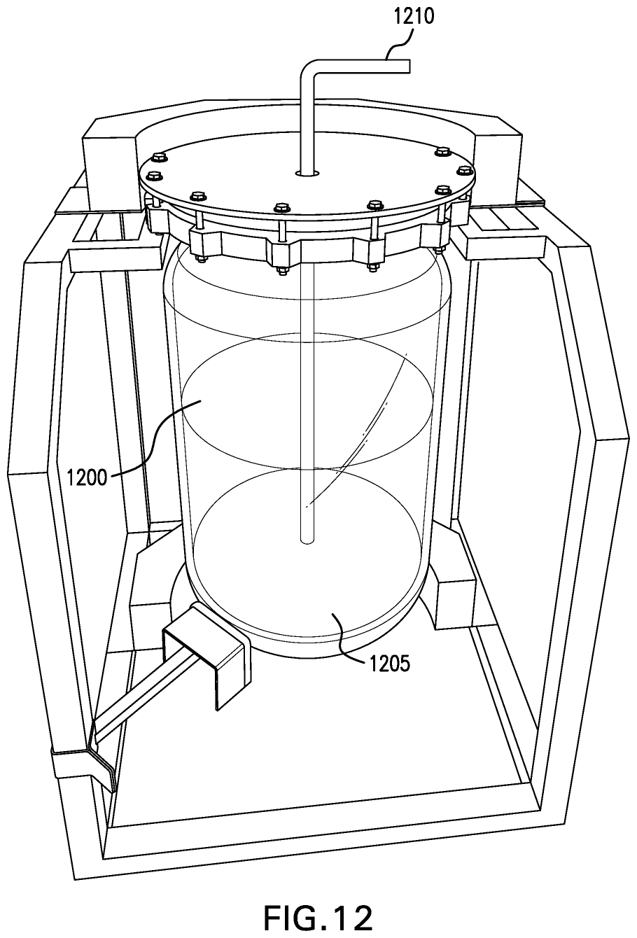

The precipitation vessel 1120 includes a first inlet valve 1130 for receiving the milled mixture, slurry or solution from the wet milling device 1110 and a second inlet valve 1170 for receiving an antisolvent from an antisolvent vessel 1160, thereby facilitating mixing of the antisolvent and the milled mixture, slurry or solution. The precipitation vessel 1120 also includes a recirculation line valve 1140 for discharging the nanoparticle precipitate mixture, slurry or solution into the wet milling device 1110, with the assistance of a peristaltic pump 1150 that is used to control the flow rate. The precipitation vessel 1120 also includes an outlet valve for discharging the nanoparticle precipitate mixture, slurry or solution into another device. A second peristaltic pump 1190 is used to prime the wet milling device 1110 through the precipitation vessel outlet valve 1180 and to maintain the flow rate. FIG. 11B shows a more detailed illustration of one example of a milling device 1110. FIG. 12 is a perspective view of a solvent (anti-solvent) tank 1200 associated with an exemplary embodiment of a containment system of the present invention, which holds solvent or anti-solvent 1205 that may be introduced into the mixing chamber 1040 of the mixing vessel 1030 via the solvent inlet 1210.

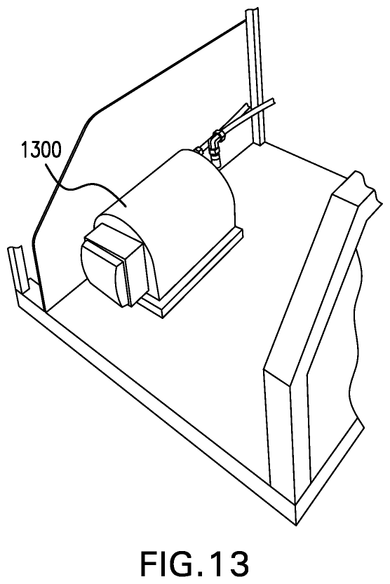

FIG. 13 shows an air pressure pump 1300 associated with an exemplary dual compartment flexible isolator in accordance with an embodiment of a containment system of the present invention.

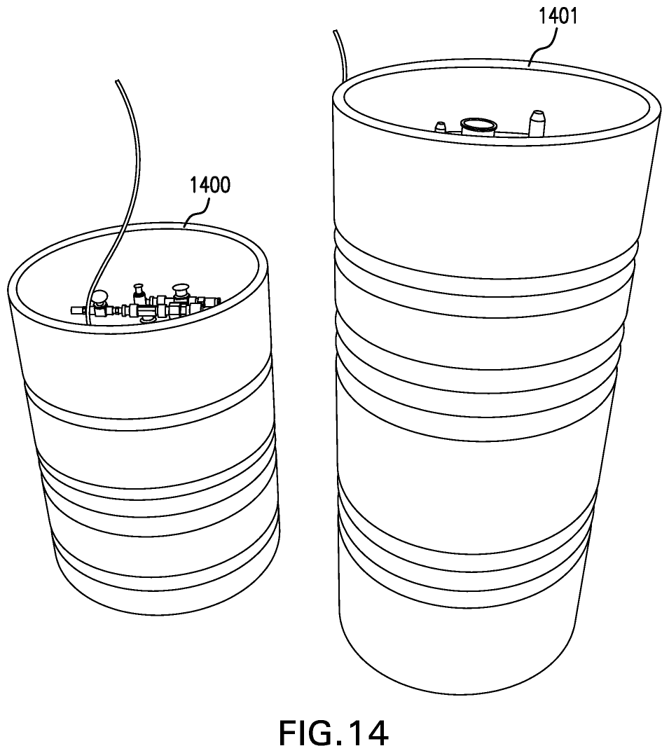

FIG. 14 is a perspective view of solvent tanks 1400 and 1401 used in accordance with various embodiments of the containment system of the present invention. The solvent tanks are the source of solvent provided to the mixing vessel in the containment systems of the invention.

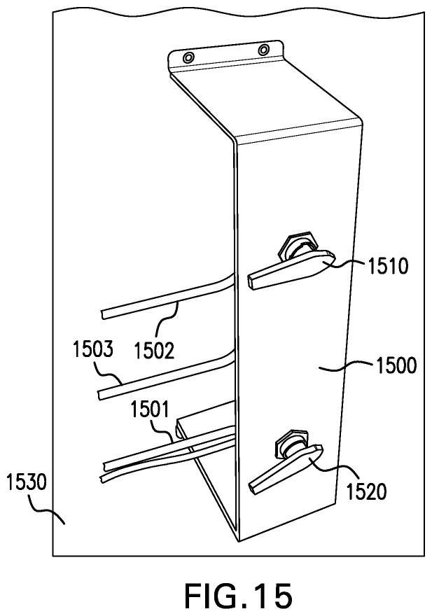

FIG. 15 is a perspective view of exemplary solvent supply line panel 1500 that may be used in accordance with various embodiments of the containment systems of the present invention. As shown in FIG. 15, the exemplary solvent supply line panel 1500 comprises two solvent input lines 1501 and 1502, and one solvent output line 1503. Handles connected to valves (not shown in FIG. 15) may be manipulated by the operator to control the amounts of solvent entering the solvent supply line panel 1500 through solvent input lines 1501 and 1502 and exiting the solvent supply line panel 1500 through solvent output line 1503. Solvent input lines 1501 and 1502 are typically connected to a solvent (or anti-solvent) tanks (such as the solvent (and anti-solvent) tanks 1200 shown in FIG. 12 and the solvent tanks 1400 and 1401 shown in FIG. 14), while the solvent output line 1503 is attached to the mixing vessel by a solvent input port on the mixing vessel. As shown in FIG. 15, the solvent supply line panel 1500 may be suitably attached to a wall 1530 located in the vicinity of the connected solvent (anti-solvent) tanks and the mixing vessel.

While the invention has been described in detail with reference to specific examples, it will be apparent to one skilled in the art that various modifications can be made within the scope of this invention. Thus, the scope of the invention should not be limited by the examples described herein, but by the claims presented below.

1. A containment system for mixing a solvent with a dry powder without exposing the dry powder to a surrounding atmosphere, wherein the dry powder is supplied to the containment system in a dry powder container having a sealed connection, the containment system comprising:
(a) a dual compartment isolator for safely removing the dry powder from the dry powder container, the dual compartment isolator including
a staging compartment,
a charging compartment,
a raw material entry port, connected to the staging compartment, the raw material entry port being configured to isolate the dry powder container from the surrounding atmosphere while transferring the dry powder container into the staging compartment,
a partition separating the staging compartment from the charging compartment,
a resealable opening in the partition that permits the dry powder container to be transferred out of the staging compartment and into the charging compartment without exposing the dry powder to the surrounding atmosphere,
a containment valve, located inside the charging compartment, the containment valve having a fitting suitably configured to mate with the sealed connection on the dry powder container, and
a negative cascading pressure controller for generating negative pressure in both the staging compartment and the charging compartment; and
(b) a mixing vessel for mixing the dry powder with the solvent, the mixing vessel including
a mixing chamber,
a solids charging port fluidly connecting the mixing chamber to the containment valve in the charging compartment of the dual compartment isolator to permit the dry powder to pass out of the dry powder container through the containment valve and into the mixing chamber without exposing the dry powder to the surrounding atmosphere,
a solvent inlet for admitting the solvent into the mixing chamber; and
an agitator for mixing the solvent and the dry powder together in the mixing chamber to produce a solvent and dry powder mixture, and
an outlet valve for discharging the solvent and dry powder mixture from the mixing chamber.

2. The containment system of claim 1, further comprising a discharge device for facilitating discharge of the dry powder mixture from the mixing chamber via the outlet valve.

3. The containment system of claim 2, wherein the discharge device comprises a pump, a positive pressure source, or a negative pressure source.

4. The containment system of claim 1, wherein the containment valve in the charging compartment comprises a split butterfly valve.

5-6. (canceled)

7. The containment system of claim 1, further comprising a second solvent inlet on the mixing vessel configured to admit a second solvent into the mixing chamber.

8. The containment system of claim 7, wherein the second solvent is an anti-solvent.

9-12. (canceled)

13. A containment system for mixing a solvent with a dry powder without exposing the dry powder to surrounding atmosphere, wherein the dry powder is supplied to the containment system in a dry powder container having a sealed connection, the containment system comprising:
a) a dual compartment flexible isolator for safely removing the dry powder from the dry powder container, the dual compartment flexible isolator including
a top portion and a bottom portion, the top portion and the bottom portion being linked together by one or more side walls, forming an interior portion, the interior portion comprising an internal wall that is sealingly connected to the side walls and that separates the interior portion into a first compartment and a second compartment;
at least one glove formed in at least one of the side walls, said at least one glove extending into the interior portion of the dual compartment flexible isolator; and
a first sealable opening formed in one of the side walls for permitting a dry powder material container to be placed inside the first compartment;
a second sealable opening formed in the internal wall for permitting the dry powder container to be moved from the first compartment into the second compartment without exposing the dry powder to surrounding atmosphere;
a containment valve, located inside the second compartment, the containment valve having a fitting suitably configured to mate with the sealed connection on the dry powder container, and
a negative cascading pressure controller for generating negative pressure within the first compartment and second compartment; and
b) a mixing vessel for mixing the dry powder with the solvent, the mixing vessel including
a mixing chamber;
a solids charging port, fluidly connecting the mixing chamber to the containment valve in the second compartment of the dual compartment flexible isolator to permit the dry powder to pass out of the dry powder container through the containment valve and into the mixing chamber without exposing the dry powder to surrounding atmosphere,
a solvent inlet for admitting the solvent into the mixing chamber;
an agitator for mixing the solvent and the dry powder together in the mixing chamber to produce a solvent and dry powder mixture; and
an outlet valve for discharging the solvent and dry powder mixture from the mixing chamber.

14. The containment system according to claim 13, wherein the containment valve in the second compartment comprises a split butterfly valve.

15. The containment system according to claim 13, wherein the dual compartment flexible isolator comprises four side walls.

16. (canceled)

17. The containment system according to claim 13, wherein the negative cascading pressure controller provides a first negative pressure differential between the outside of the dual compartment flexible isolator and the first compartment of about 0.01 to about 0.5 inches of water (first negative pressure differential as referenced from the outside of the dual compartment flexible isolator), and a second negative pressure differential between the first compartment and the second compartment of about 0.01 to about 0.5 inches of water (second negative pressure differential referenced from the inside of the first compartment of the dual compartment flexible isolator).

18-19. (canceled)

20. The containment system according to claim 13, further comprising an additional port for connecting the dual compartment flexible isolator to another device.

21. The containment system according to claim 20, wherein said additional port may be selectively connected to (i) a vacuum source, and (ii) a source of inert gas, whereby air within said dual compartment flexible isolator may be replaced by inert gas.

22-25. (canceled)

26. A dual compartment flexible isolator comprising:
a top portion and a bottom portion, the top portion and the bottom portion being linked together by one or more side walls, forming an interior portion, the interior portion, comprising an internal wall that is sealingly connected to the side walls and that separates the interior portion into a first compartment and a second compartment;
at least one glove formed in at least one of the side walls, said at least one glove extending into the interior portion of the dual compartment flexible isolator; and
a first sealable opening formed in one of the side walls for permitting a dry powder material container to be placed inside the first compartment;
a second sealable opening formed in the internal wall for permitting the dry powder material container to be moved from the first compartment into the second compartment without exposing dry powder material in said dry powder material container to surrounding atmosphere;
a containment valve, located inside the second compartment, the containment valve having a fitting suitably configured to mate with a sealed connection on the dry powder material container; and
a negative cascading pressure controller for generating negative pressure within the first compartment and second compartment.

27. The dual compartment flexible isolator according to claim 26, wherein the containment valve in the second compartment comprises a split butterfly valve.

28. The dual compartment flexible isolator according to claim 26, further comprising a port for connecting the dual compartment flexible isolator to another device.

29-30. (canceled)

31. A containment system for mixing a solvent with a dry powder without exposing the dry powder to a surrounding atmosphere, comprising:
a) a primary containment subsystem comprising a containment valve with a fitting configured to accept a sealed connection on a dry powder container, and a connection to solids charging port of a mixing vessel; and
b) a secondary containment subsystem comprising the mixing vessel,
a dual compartment flexible isolator, and
a negative cascading pressure controller.

32. The containment system of claim 31, further comprising a tertiary containment subsystem comprising a negatively-pressurized room, or a down-flow booth, or a gas exhaust, or a solvent exhaust, or protective flooring, or a single-use protective curtain, or a combination of one or more thereof.

33. The containment system according to claim 31, wherein the dual compartment flexible isolator comprises:
a staging compartment,
a charging compartment,
a raw material entry port, connected to the staging compartment, the raw material entry port being configured to isolate the dry powder container from the surrounding atmosphere while transferring the dry powder container into the staging compartment,
a partition separating the staging compartment from the charging compartment, and
a resealable opening in the partition that permits the dry powder container to be transferred out of the staging compartment and into the charging compartment without exposing the dry powder to the surrounding atmosphere.

34-35. (canceled)

36. A method of producing a slurry or solution from a dry powder and a solvent, comprising:
providing a dual compartment isolator, the dual compartment isolator comprising a staging compartment, a raw material entry port connected to the staging compartment, a charging compartment, a containment valve located in the charging compartment, and a partition between the staging compartment and the charging compartment,
connecting a negative cascading pressure controller to the dual compartment isolator;
providing a mixing vessel comprising a solvent inlet, a mixing chamber and a solids charging port fluidly connected to the mixing chamber;
receiving a dry powder container containing the dry powder, the dry powder container having a sealed connection;
activating the negative cascading pressure controller to produce negative pressure in both the staging compartment and the charging compartment of the dual compartment isolator;
admitting the dry powder container into the staging compartment via the raw material entry port;
transferring the dry powder container from the staging compartment to the charging compartment by passing the dry powder container through a resealable opening in the partition;
closing the resealable opening in the partition;
connecting the sealed connection on the dry powder container to a fitting on one end of the containment valve in the charging compartment of the dual compartment isolator;
connecting the solids charging port on the mixing vessel to an opposite end of the containment valve;
opening the sealed connection on the dry powder container and the fitting on the containment valve to permit the dry powder to pass out of the dry powder container in the charging compartment of the dual compartment isolator, through the sealed connection and the fitting and the solids charging port, and into the mixing chamber of the mixing vessel;
introducing the solvent into the mixing chamber of the mixing vessel via the solvent inlet; and
agitating the dry powder and the solvent in the mixing chamber to produce the slurry or solution.

37-38. (canceled)

39. The method according to claim 36, wherein:
the mixing vessel further comprises a second solvent inlet; and
the method further comprises
(i) introducing an anti-solvent into the mixing chamber of the mixing vessel via the second solvent inlet, and
(ii) agitating the dry powder and the anti-solvent in the mixing chamber to produce the slurry.

40-42. (canceled)

43. The method according to claim 36, further comprising:
(i) attaching a transfer device to the mixing vessel; and
(ii) activating the transfer device to facilitate discharging the slurry or solution out of the mixing vessel.

44. The method of claim 43, wherein the transfer device comprises a pump, a positive pressure source, or a negative pressure source.
